(19) United States
(12) Patent Application Publication
(10) Pub. No.: US 2022/0046688 A1
(43) Pub. Date: Feb. 10, 2022

(54) METHOD AND APPARATUS FOR TRANSMITTING/RECEIVING WIRELESS SIGNAL IN WIRELESS COMMUNICATION SYSTEM

(71) Applicant: LG Electronics Inc., Seoul (KR)

(72) Inventors: Suckchel YANG, Seoul (KR); Seonwook KIM, Seoul (KR); Daesung HWANG, Seoul (KR)

(21) Appl. No.: 17/396,132

(22) Filed: Aug. 6, 2021

Related U.S. Application Data
(60) Provisional application No. 63/062,400, filed on Aug. 6, 2020.

(51) Int. Cl. H04W 72/12

(52) U.S. Cl. CPC H04W 72/1289

(57) ABSTRACT

The present disclosure relates to a wireless communication system, and more particularly, to a method including: receiving DCI defined for multi-carrier scheduling, the DCI including: resource allocation information for one or more carriers, and a single field for bandwidth part switching; and performing a bandwidth part switching operation on one of multi-carriers, wherein, based on two or more carriers being scheduled by the DCI, the bandwidth part switching operation is performed on one of the multi-carriers based on a pre-determined rule, and wherein, based on one carrier being scheduled by the DCI, the bandwidth part switching operation is performed on the scheduled carrier of the multi-carriers.

### CROSS-REFERENCE TO RELATED APPLICATION

This application claims the benefit of U.S. provisional Patent Application No. 63/062,400, filed on Aug. 6, 2020, which is hereby incorporated by reference as if fully set forth herein.

### TECHNICAL FIELD

The present disclosure relates to a wireless communication system, and more particularly, to a method and apparatus for transmitting and receiving a wireless signal.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### SUMMARY

An aspect of the present disclosure is to provide a method and apparatus for efficiently transmitting and receiving a wireless signal.

It will be appreciated by persons skilled in the art that the objects that could be achieved with the present disclosure are not limited to what has been particularly described hereinabove and the above and other objects that the present disclosure could achieve will be more clearly understood from the following detailed description.

In a first aspect of the present disclosure, a method used by a user equipment (UE) in a wireless communication system is provided, wherein the method comprises: receiving downlink control information (DCI) defined for multi-carrier scheduling, the DCI including: resource allocation information for one or more carriers, and a single field for bandwidth part switching; and performing a bandwidth part switching operation on one of multi-carriers, wherein, based on two or more carriers being scheduled by the DCI, the bandwidth part switching operation is performed on one of the multi-carriers based on a pre-determined rule, and wherein, based on one carrier being scheduled by the DCI, the bandwidth part switching operation is performed on the scheduled carrier of the multi-carriers.

In a second aspect of the present disclosure, a user equipment (UE) used in a wireless communication system is provided, wherein the UE includes at least one radio frequency (RF) units, at least one processor, and at least one computer memory operably coupled to the at least one processor and, when executed, causing the at least one processor to perform operations. The operations include: receiving downlink control information (DCI) defined for multi-carrier scheduling, the DCI including: resource allocation information for one or more carriers, and a single field for bandwidth part switching; and performing a bandwidth part switching operation on one of multi-carriers, wherein, based on two or more carriers being scheduled by the DCI, the bandwidth part switching operation is performed on one of the multi-carriers based on a pre-determined rule, and wherein, based on one carrier being scheduled by the DCI, the bandwidth part switching operation is performed on the scheduled carrier of the multi-carriers.

In a third aspect of the present disclosure, an apparatus for a UE is provided, wherein the apparatus includes at least one processor, and at least one computer memory operably coupled to the at least one processor and, when executed, causing the at least one processor to perform operations. The operations include: receiving downlink control information (DCI) defined for multi-carrier scheduling, the DCI including: resource allocation information for one or more carriers, and a single field for bandwidth part switching; and performing a bandwidth part switching operation on one of multi-carriers, wherein, based on two or more carriers being scheduled by the DCI, the bandwidth part switching operation is performed on one of the multi-carriers based on a pre-determined rule, and wherein, based on one carrier being scheduled by the DCI, the bandwidth part switching operation is performed on the scheduled carrier of the multi-carriers.

In a fourth aspect of the present disclosure, a computer-readable storage medium including at least one computer program which, when executed, causes at least processor to perform operations is provided. The operations include: receiving downlink control information (DCI) defined for multi-carrier scheduling, the DCI including: resource allocation information for one or more carriers, and a single field for bandwidth part switching; and performing a bandwidth part switching operation on one of multi-carriers, wherein, based on two or more carriers being scheduled by the DCI, the bandwidth part switching operation is performed on one of the multi-carriers based on a pre-determined rule, and wherein, based on one carrier being scheduled by the DCI, the bandwidth part switching operation is performed on the scheduled carrier of the multi-carriers.

In a fifth aspect of the present disclosure, a method used by a base station (BS) in a wireless communication system is provided, wherein the method includes: transmitting downlink control information (DCI) defined for multi-carrier scheduling, the DCI including: resource allocation information for one or more carriers, and a single field for bandwidth part switching; and performing a bandwidth part switching operation on one of multi-carriers, wherein, based on two or more carriers being scheduled by the DCI, the bandwidth part switching operation is performed on one of the multi-carriers based on a pre-determined rule, and wherein, based on one carrier being scheduled by the DCI, the bandwidth part switching operation is performed on the scheduled carrier of the multi-carriers.

In a sixth aspect of the present disclosure, a BS used in a wireless communication system is provided, wherein the BS includes at least one radio frequency (RF) units, at least one processor, and at least one computer memory operably coupled to the at least one processor and, when executed, causing the at least one processor to perform operations. The operations include: transmitting downlink control information (DCI) defined for multi-carrier scheduling, the DCI including: resource allocation information for one or more carriers, and a single field for bandwidth part switching; and performing a bandwidth part switching operation on one of multi-carriers, wherein, based on two or more carriers being scheduled by the DCI, the bandwidth part switching operation is performed on one of the multi-carriers based on a pre-determined rule, and wherein, based on one carrier being scheduled by the DCI, the bandwidth part switching operation is performed on the scheduled carrier of the multi-carriers.

The pre-determined rule may include: the bandwidth part switching operation is performed on one of the multi-carriers having a lowest cell index.

The pre-determined rule may include: the bandwidth part switching operation is performed on a primary cell (PCell) of the multi-carriers.

The pre-determined rule may include: the bandwidth part switching operation is performed on a scheduling cell of the multi-carriers.

The DCI may further include: 2-bit redundancy version (RV) field, wherein based on two carriers being scheduled by the DCI, each 1-bit value of the RV field indicates one of two RVs {0, x} (x is 2 or 3) for a respective one of the multi-carriers, and wherein, based on one carrier being scheduled by the DCI, 2-bit value of the RV field indicates one of four RVs {0, 1, 2, 3} for the scheduled carrier of the multi-carriers.

According to the present disclosure, a wireless signal may be transmitted and received efficiently in a wireless communication system.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 illustrates physical channels used in a 3rd generation partnership project (3GPP) system as an exemplary wireless communication systems and a general signal transmission method using the same;

FIG. 2 illustrates a radio frame structure;

FIG. 3 illustrates a resource grid of a slot;

FIG. 4 illustrates mapping of physical channels in a slot;

FIG. 5 illustrates a procedure of PDCCH transmission/reception;

FIG. 6 illustrates an acknowledgment/negative acknowledgement (ACK/NACK) transmission process;

FIG. 7 illustrates a physical uplink shared channel (PUSCH) transmission process;

FIG. 8 illustrates a scheduling method in a multi-carrier situation;

FIGS. 9 to 10 illustrate proposed multi-CC scheduling according to an example of the present disclosure; and

FIGS. 11 to 14 illustrate a communication system 1 and wireless devices, which are applied to the present disclosure.

### DETAILED DESCRIPTION

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive machine type communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and ultra-reliable and low latency communication (URLLC) is being discussed. In the present disclosure, for simplicity, this technology will be referred to as NR (New Radio or New RAT).

For the sake of clarity, 3GPP NR is mainly described, but the technical idea of the present disclosure is not limited thereto.

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

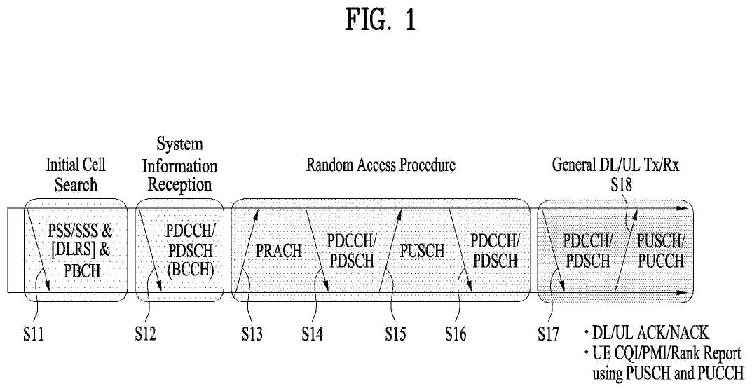

FIG. 1 illustrates physical channels used in a 3GPP NR system and a general signal transmission method using the same.

When powered on or when a UE initially enters a cell, the UE performs initial cell search involving synchronization with a BS in step S101. For initial cell search, the UE receives synchronization signal block (SSB). The SSB includes a primary synchronization signal (PSS), a secondary synchronization signal (SSS), and a physical broadcast channel (PBCH). The UE synchronizes with the BS and acquires information such as a cell Identifier (ID) based on the PSS/SSS. Then the UE may receive broadcast information from the cell on the PBCH. In the meantime, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

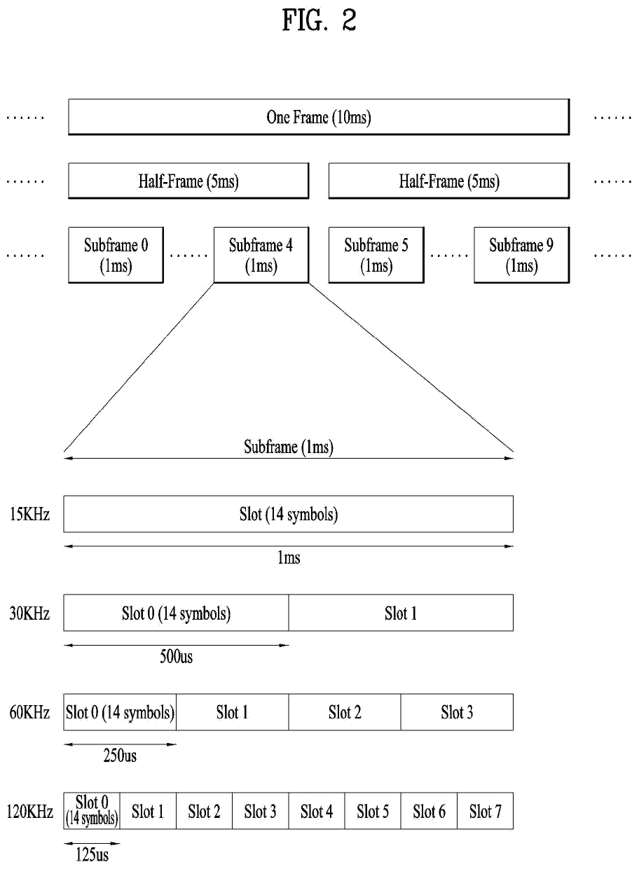

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 orthogonal frequency division multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15 * 2\hat{ }u) | N^{slot}_{symb} | N^{frame,u}ₛₗₒₜ | N^{subframe,u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

* N^{slot}_{symb}: Number of symbols in a slot
* N^{frame,u}ₛₗₒₜ: Number of slots in a frame
* N^{subframe,u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15 * 2\hat{ }u) | N^{slot}_{symb} | N^{frame,u}ₛₗₒₜ | N^{subframe,u}ₛₗₒₜ |
|---|---|---|---|
| 60 KHz (u = 2) | 12 | 40 | 4 |

The frame structure is merely an example. The number of subframes, the number of slots, and the number of symbols in a frame may vary.

In the NR system, different OFDM numerologies (e.g., SCSs) may be configured for a plurality of cells aggregated for one UE. Accordingly, the (absolute time) duration of a time resource including the same number of symbols (e.g., a subframe (SF), slot, or TTI) (collectively referred to as a time unit (TU) for convenience) may be configured to be different for the aggregated cells. A symbol may be an OFDM symbol (or CP-OFDM symbol) or an SC_FDMA symbol (or a discrete Fourier transform-spread-OFDM (DFT-s-OFDM) symbol).

In NR, various numerologies (or SCSs) are supported to support various 5G services. For example, with an SCS of 15 kHz, a wide area in traditional cellular bands is supported, while with an SCS of 30 kHz/60 kHz, a dense urban area, a lower latency, and a wide carrier bandwidth are supported. With an SCS of 60 kHz or higher, a bandwidth larger than 24.25 GHz is be supported to overcome phase noise.

An NR frequency band may be defined by two types of frequency ranges, FR1 and FR2. FR1 and FR2 may be configured as described in Table 3. FR2 may refer to millimeter wave (mmW).

TABLE 3

| Frequency Range | Corresponding frequency | |
|---|---|---|
| designation | range | Subcarrier Spacing |
| FR1 | 450 MHz-7125 MHz | 15, 30, 60 kHz |
| FR2 | 24250 MHz-52600 MHz | 60, 120, 240 kHz |

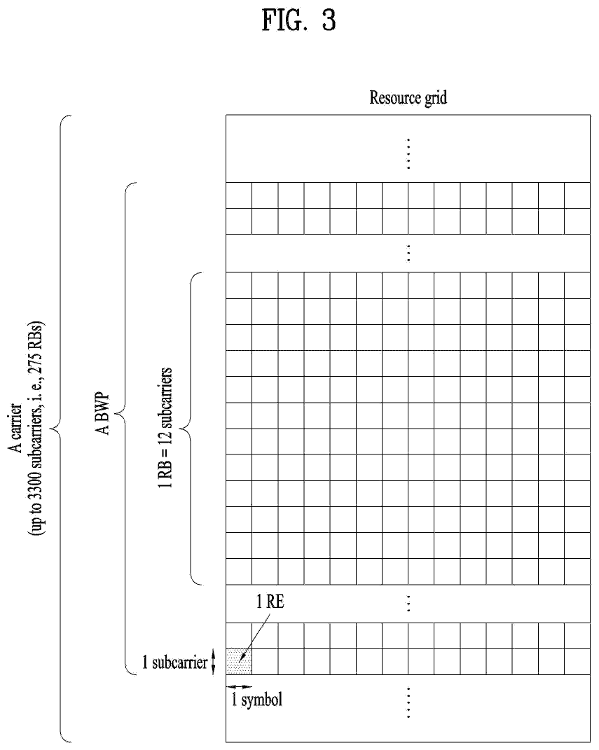

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

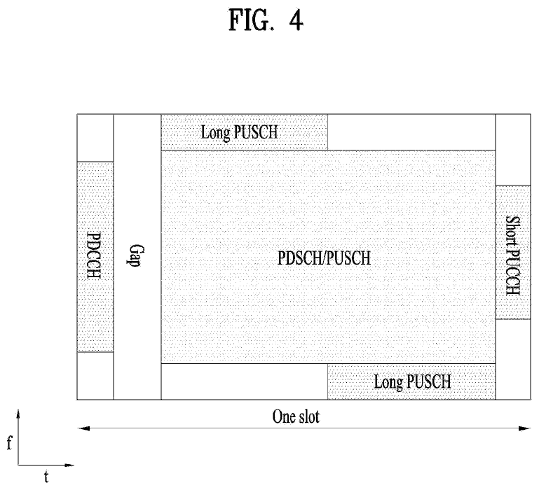

FIG. 4 illustrates exemplary mapping of physical channels in a slot. In the NR system, a frame is characterized by a self-contained structure in which all of a DL control channel, DL or UL data, and a UL control channel may be included in one slot. For example, the first N symbols of a slot may be used for a DL control channel (e.g., PDCCH) (hereinafter, referred to as a DL control region), and the last M symbols of the slot may be used for a UL control channel (e.g., PUCCH) (hereinafter, referred to as a UL control region). Each of N and M is an integer equal to or larger than 0. A resource area (referred to as a data region) between the DL control region and the UL control region may be used for transmission of DL data (e.g., PDSCH) or UL data (e.g., PUSCH). A guard period (GP) provides a time gap for switching between a transmission mode and a reception mode at the BS and the UE. Some symbol at the time of switching from DL to UL may be configured as a GP.

The PDCCH carries downlink control information (DCI). For example, the PCCCH (i.e., DCI) carries a transmission format and resource allocation of a downlink shared channel (DL-SCH), resource allocation information about an uplink shared channel (UL-SCH), paging information about a paging channel (PCH), system information present on the DL-SCH, resource allocation information about a higher layer control message such as a random access response transmitted on a PDSCH, a transmit power control command, and activation/release of configured scheduling (CS). The DCI includes a cyclic redundancy check (CRC). The CRC is masked/scrambled with different identifiers (e.g., radio network temporary identifier (RNTI)) according to the owner or usage of the PDCCH. For example, if the PDCCH is for a specific UE, the CRC will be masked with a UE identifier (e.g., cell-RNTI (C-RNTI)). If the PDCCH is for paging, the CRC will be masked with a paging-RNTI (P-RNTI). If the PDCCH is for system information (e.g., a system information block (SIB)), the CRC will be masked with a system information RNTI (SI-RNTI). If the PDCCH is for a random access response, the CRC will be masked with a random access-RNTI (RA-RNTI).

The PUCCH carries uplink control information (UCI). The UCI includes the following information.
Scheduling Request (SR): Information that is used to request a UL-SCH resource.
Hybrid Automatic Repeat Request (HARQ)-Acknowledgment (ACK): A response to a downlink data packet (e.g., codeword) on the PDSCH. HARQ-ACK indicates whether the downlink data packet has been successfully received. In response to a single codeword, one bit of HARQ-ACK may be transmitted. In response to two codewords, two bits of HARQ-ACK may be transmitted. The HARQ-ACK response includes positive ACK (simply, ACK), negative ACK (NACK), DTX or NACK/DTX. Here, the HARQ-ACK is used interchangeably used with HARQ ACK/NACK and ACK/NACK.
Channel State Information (CSI): Feedback information about a downlink channel. Multiple input multiple output (MIMO)-related feedback information includes a rank indicator (RI) and a precoding matrix indicator (PMI).

Table 4 exemplarily shows PUCCH formats. PUCCH formats may be divided into short PUCCHs (Formats 0 and 2) and long PUCCHs (Formats 1, 3, and 4) based on the PUCCH transmission duration.

TABLE 4

| | Length in | | | |
|---|---|---|---|---|
| | OFDM | | | |
| PUCCH | symbols | Number | | |
| format | N^{PUCCH}_{symb} | of bits | Usage | Etc |
| 0 | 1-2 | ≤2 | HARQ, SR | Sequence selection |
| 1 | 4-14 | ≤2 | HARQ, [SR] | Sequence |
| | | | | modulation |
| 2 | 1-2 | >2 | HARQ, CSI, | CP-OFDM |
| | | | [SR] | |
| 3 | 4-14 | >2 | HARQ, CSI, | DFT-s-OFDM |
| | | | [SR] | (no UE |
| | | | | multiplexing) |
| 4 | 4-14 | >2 | HARQ, CSI, | DFT-s-OFDM |
| | | | [SR] | (Pre DFT OCC) |

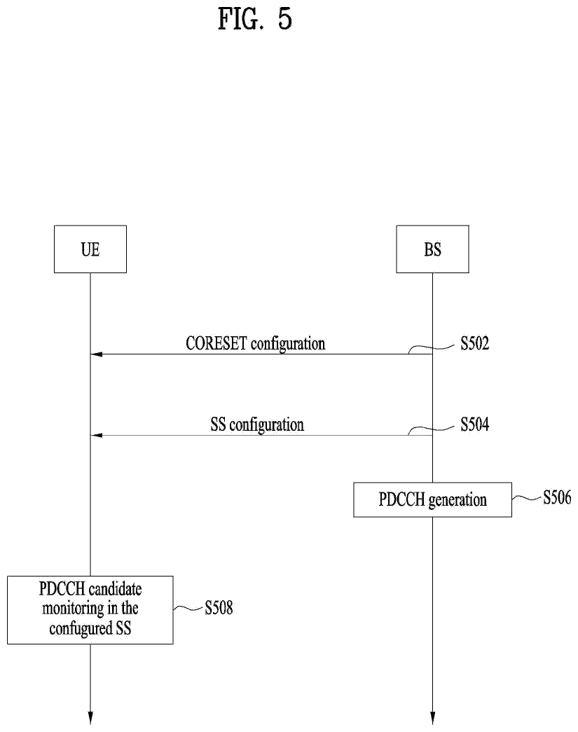

FIG. 5 illustrates an exemplary PDCCH transmission/reception procedure.

Referring to FIG. 5, a BS may transmit a control resource set (CORESET) configuration to a UE (S502). A CORESET is defined as a set of resource element groups (REGs) with a given numerology (e.g., an SCS, a CP length, and so on). An REG is defined by one OFDM symbol and one (P)RB. A plurality of CORESETs for one UE may overlap with each other in the time/frequency domain. A CORESET may be configured by system information (e.g., a master information block (MIB)) or UE-specific higher-layer signaling (e.g., radio resource control (RRC) signaling). The UE-specific RRC signaling may include, for example, an RRC setup message, BWP configuration information, and so on. Specifically, the CORESET configuration may include the following information/fields.
controlResourceSetId: indicates the ID of a CORESET.
frequencyDomainResources: indicates the frequency resources of the CORESET. The frequency resources of the CORESET are indicated by a bitmap in which each bit corresponds to an RBG (e.g., six (consecutive) RBs). For example, the most significant bit (MSB) of the bitmap corresponds to a first RBG. RBGs corresponding to bits set to 1 are allocated as the frequency resources of the CORESET.
duration: indicates the time resources of the CORESET. Duration indicates the number of consecutive OFDM symbols included in the CORESET. Duration has a value of 1 to 3.
cce-REG-MappingType: indicates a control channel element (CCE)-REG mapping type. Interleaved and non-interleaved types are supported.
interleaverSize: indicates an interleaver size.
pdcch-DMRS-ScramblingID: indicates a value used for PDCCH DMRS initialization. When pdcch-DMRS-ScramblingID is not included, the physical cell ID of a serving cell is used.
precoderGranularity: indicates a precoder granularity in the frequency domain.
reg-BundleSize: indicates an REG bundle size.
tci-PresentInDCI: indicates whether a transmission configuration index (TCI) field is included in DL-related DCI.
tci-StatesPDCCH-ToAddList: indicates a subset of TCI states configured in pdcch-Config, used for providing quasi-co-location (QCL) relationships between DL RS(s) in an RS set (TCI-State) and PDCCH DMRS ports.

Further, the BS may transmit a PDCCH search space (SS) configuration to the UE (S504). A PDCCH SS set includes PDCCH candidates. A PDCCH candidate is CCE(s) that the UE monitors to receive/detect a PDCCH. The monitoring includes blind decoding (BD) of PDCCH candidates. One PDCCH (candidate) includes 1, 2, 4, 8, or 16 CCEs according to an aggregation level (AL). One CCE includes 6 REGs. Each CORESET configuration is associated with one or more SSs, and each SS is associated with one CORESET configuration. One SS is defined based on one SS configuration, and the SS configuration may include the following information/fields.
searchSpaceId: indicates the ID of an SS.
controlResourceSetId: indicates a CORESET associated with the SS.
monitoringSlotPeriodicityAndOffset: indicates a periodicity (in slots) and offset (in slots) for PDCCH monitoring.
monitoringSymbolsWithinSlot: indicates the first OFDM symbol(s) for PDCCH monitoring in a slot configured with PDCCH monitoring. The first OFDM symbol(s) for PDCCH monitoring is indicated by a bitmap with each bit corresponding to an OFDM symbol in the slot. The MSB of the bitmap corresponds to the first OFDM symbol of the slot. OFDM symbol(s) corresponding to bit(s) set to 1 corresponds to the first symbol(s) of a CORESET in the slot.
nrofCandidates: indicates the number of PDCCH candidates (one of values 0, 1, 2, 3, 4, 5, 6, and 8) for each AL where AL={1, 2, 4, 8, 16}.
searchSpaceType: indicates common search space (CSS) or UE-specific search space (USS) as well as a DCI format used in the corresponding SS type.

Subsequently, the BS may generate a PDCCH and transmit the PDCCH to the UE (S506), and the UE may monitor PDCCH candidates in one or more SSs to receive/detect the PDCCH (S508). An occasion (e.g., time/frequency resources) in which the UE is to monitor PDCCH candidates is defined as a PDCCH (monitoring) occasion. The UE may determine a PDCCH monitoring occasion on an active DL BWP in a slot according to a PDCCH monitoring periodicity, a PDCCH monitoring offset, and a PCCH monitoring pattern. One or more PDCCH (monitoring) occasions may be configured in a slot.

Table 3 shows the characteristics of each SS.

TABLE 3

| | Search | | |
|---|---|---|---|
| Type | Space | RNTI | Use Case |
| Type0- | Common | SI-RNTI on a primary cell | SIB Decoding |
| PDCCH | | | |
| Type0A- | Common | SI-RNTI on a primary cell | SIB Decoding |
| PDCCH | | | |
| Type1- | Common | RA-RNTI or TC-RNTI on a | Msg2, Msg4 |
| PDCCH | | primary cell | decoding in |
| | | | RACH |
| Type2- | Common | P-RNTI on a primary cell | Paging Decoding |
| PDCCH | | | |
| Type3- | Common | INT-RNTI, SFI-RNTI, | |
| PDCCH | | TPC-PUSCH-RNTI, | |
| | | TPC-PUCCH-RNTI, | |
| | | TPC-SRS-RNTI, C-RNTI, | |
| | | MCS-C-RNTI, or | |
| | | CS-RNTI(s) | |
| | UE | C-RNTI, or MCS-C-RNTI, | User specific |
| | Specific | or CS-RNTI(s) | PDSCH decoding |

Table 4 shows DCI formats transmitted on the PDCCH.

TABLE 4

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

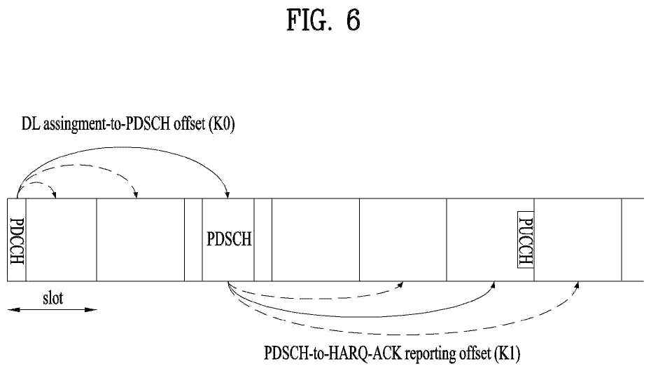

FIG. 6 illustrates an ACK/NACK transmission procedure. Referring to FIG. 6, the UE may detect a PDCCH in slot #n. Here, the PDCCH includes downlink scheduling information (e.g., DCI format 1_0 or 1_1). The PDCCH indicates a DL assignment-to-PDSCH offset (K0) and a PDSCH-HARQ-ACK reporting offset (K1). For example, DCI format 1_0 or 1_1 may include the following information.
Frequency domain resource assignment (FDRA): Indicates an RB set assigned to the PDSCH.
Time domain resource assignment (TDRA): Indicates K0 and the starting position (e.g. OFDM symbol index) and duration (e.g. the number of OFDM symbols) of the PDSCH in a slot. TDRA may be indicated by a start and length indicator value (SLIV).
PDSCH-to-HARQ feedback timing indicator: Indicates K1.
HARQ process number (4 bits): Indicates an HARQ process identify (ID) for data (e.g., PDSCH or TB).
PUCCH resource indicator (PRI): Indicates PUCCH resources to be used for UCI transmission among a plurality of resources in a PUCCH resource set.

After receiving the PDSCH in slot #(n+K0) according to the scheduling information of slot #n, the UE may transmit UCI on the PUCCH in slot #(n+K1). Here, the UCI includes a HARQ-ACK response to the PDSCH. In the case where the PDSCH is configured to transmit a maximum of one TB, the HARQ-ACK response may be configured in one bit. In the case where the PDSCH is configured to transmit a maximum of two TBs, the HARQ-ACK response may be configured in two bits if spatial bundling is not configured and may be configured in one bit if spatial bundling is configured. When slot #(n+K1) is designated as a HARQ-ACK transmission time for a plurality of PDSCHs, the UCI transmitted in slot #(n+K1) includes HARQ-ACK responses to the plurality of PDSCHs.

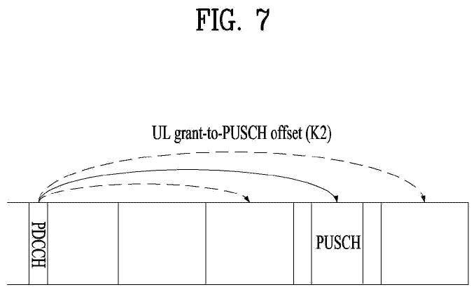

FIG. 7 illustrates an exemplary PUSCH transmission process. Referring to FIG. 7, the UE may detect a PDCCH in slot #n. The PDCCH may include UL scheduling information (e.g., DCI format 0_0 or DCI format 0_1). DCI format 0_0 and DCI format 0_1 may include the following information.
Frequency domain resource assignment: Indicates an RB set allocated to a PUSCH.
Time domain resource assignment: Specifies a slot offset K2 indicating the starting position (e.g., symbol index) and length (e.g., the number of OFDM symbols) of the PUSCH in a slot. The starting symbol and length of the PUSCH may be indicated by a start and length indicator value (SLIV), or separately.

The UE may then transmit a PUSCH in slot #(n+K2) according to the scheduling information in slot #n. The PUSCH includes a UL-SCH TB. When PUCCH transmission time and PUSCH transmission time overlaps, UCI can be transmitted via PUSCH (PUSCH piggyback).

In NR, a wider UL/DL bandwidth may be supported by aggregating a plurality of UL/DL carriers (i.e., carrier aggregation (CA)). A signal may be transmitted/received over a plurality of carriers by CA. When CA is applied, each carrier (see FIG. 3) may be referred to as a component carrier (CC). CCs may be contiguous or non-contiguous in the frequency domain. The bandwidth of each CC may be determined independently. Asymmetric CA is also available, in which the number of UL CCs is different from the number of DL CCs. In NR, radio resources are divided into/managed in cells, and a cell may include one DL CC and zero to two UL CCs. For example, a cell may include (i) only one DL CC, (ii) one DL CC and one UL CC, or (iii) one DL CC and two UL CCs (including one supplementary UL CC). Cells are classified as follows. In the present disclosure, a cell may be interpreted in the context. For example, a cell may mean a serving cell. Further, operations described herein may be applied to each serving cell, unless otherwise specified.
PCell (Primary Cell): For a UE configured with CA, a cell operating in a primary frequency (e.g., primary component carrier (PCC)) in which the UE performs an initial connection establishment procedure or initiates a connection re-establishment procedure. In dual connectivity (DC), a master cell group (MCG) cell operating in a primary frequency in which a UE performs the initial connection establishment procedure or initiates the connection re-establishment procedure.
SCell (Secondary Cell): For a UE configured with CA, an additional cell that provides radio resources, except a special cell.
PSCell (Primary SCG Cell): In DC, a secondary cell group (SCG) cell in which a UE performs random access during RRC reconfiguration and synchronization.
Special Cell (SpCell): In DC, a special cell is the PCell of an MCG or the PSCell of an SCG. Otherwise (i.e., in non-DC), a special cell is a PCell.
Serving Cell (ServCell): A cell configured for an RRC CONNECTED UE. When CA/DC is not configured, there is only one serving cell (i.e., PCell). When CA/DC is configured, a serving cell is a cell set including SpCell(s) and all SCells.

Control information may be configured to be transmitted and received only in a specific cell. For example, UCI may be transmitted only in an SpCell (e.g., PCell). When an SCell allowed for PUCCH transmission (hereinafter, referred to as PUCCH-SCell) is configured, UCI may also be transmitted in the PUCCH-SCell. In another example, the BS may allocate a scheduling cell (set) to reduce the PDCCH BD complexity of the UE. For PDSCH reception/PUSCH transmission, the UE may perform PDCCH detection/decoding only in the scheduling cell. Further, the BS may transmit a PDCCH only in the scheduling cell (set). For example, data (e.g., a PDSCH or a PUSCH) transmitted in one cell (or an active BWP in the cell) (hereinafter, a cell may be replaced with an (active) BWP in the cell) may be scheduled by a PDCCH in the cell (self-carrier scheduling (SCS)). Further, a PDCCH for a DL assignment may be transmitted in cell #0 (i.e., a scheduling cell) and a corresponding PDSCH may be transmitted in cell #2 (i.e., a scheduled cell) (cross-carrier scheduling (CCS)). The scheduling cell (set) may be configured UE-specifically, UE group-specifically, or cell-specifically. The scheduling cell includes an SpCell (e.g., PCell).

For CCS, a carrier indicator field (CIF) is used. The CIF may be disabled/enabled semi-statically by UE-specific (or UE group-specific) higher-layer signaling (e.g., RRC signaling). The CIF is an x-bit field (e.g., x=3) of a PDCCH (i.e., DCI) and may be used to indicate the (serving) cell index of a scheduled cell.
CIF disabled: The PDCCH does not include the CIF. The PDCCH in the scheduling cell allocates PDSCH/PUSCH resources in the same cell. That is, the scheduling cell is identical to the scheduled cell.
CIF enabled: The PDCCH includes the CIF. The PDCCH in the scheduling cell may allocate PDSCH/PUSCH resources in one of a plurality of cells by the CIF. The scheduling cell may be identical to or different from the scheduled cell. A PDSCH/PUSCH means a PDSCH or a PUSCH.

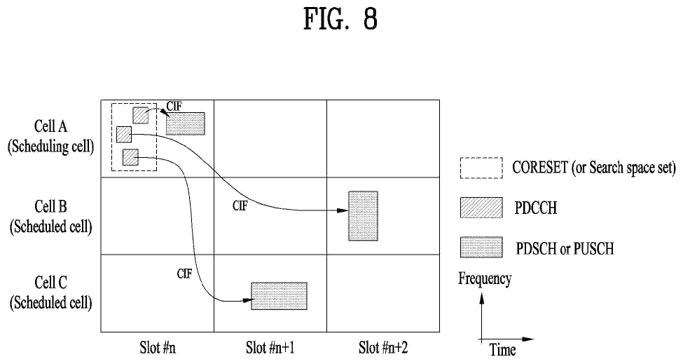

FIG. 8 illustrates exemplary scheduling in the case of multi-cell aggregation. Referring to FIG. 8, it is assumed that three cells are aggregated. When the CIF is disabled, only a PDCCH that schedules a PDSCH/PUSCH in each cell may be transmitted in the cell (SCS). On the contrary, when the CIF is enabled by UE-specific (or UE group-specific or cell-specific) higher-layer signaling, and cell A is configured as a scheduling cell, a PDCCH that schedules a PDSCH/PUSCH in another cell (i.e., a scheduled cell) as well as a PDCCH that schedules a PDSCH/PUSCH in cell A may be transmitted in cell A (CCS). In this case, no PDCCH that schedules a PDSCH/PUSCH in cell B/C is transmitted in cell B/C.

### Example: Multi-CC Scheduling

In 3GPP NR CA, only single-CC scheduling is currently used, in which a single (serving) cell/CC (a PDSCH/PUSCH transmission in the cell/CC) is scheduled by a single DCI. To reduce DCI overhead involved in PDSCH/PUSCH scheduling in the CA situation, multi-CC scheduling may be considered, in which a plurality of (serving) cells/CCs (PDSCH/PUSCH transmissions in the cells/CCs) are scheduled by a single DCI.

In this regard, a specific field configuration for DCI that performs multi-CC scheduling (multi-CC DCI) and a corresponding scheduling information signaling method are proposed. Specifically, several DCI field types may be classified according to the property of each DCI field and a related different configuration/indication method may be applied, according to the proposed methods of the present disclosure.

While (up to) two cells are assumed/considered to be schedulable simultaneously by a single multi-CC DCI in the present disclosure, for convenience of description, the operation principle of the proposed methods of the present disclosure may be equally applied to a case in which three or more cells are simultaneously scheduled by a single multi-CC DCI.

[DCI Field Type 1]

1) DCI field Type 1 refers to the type/information of a DCI field having each state mapped to information/a value configured by RRC signaling or MAC signaling.

For example, DCI field Type 1 may include time domain RA (TDRA) information, resources to be rate-matched, HARQ-ACK timing (slot offset K1) information, (Tx/Rx beam-related) TCI information, SRS transmission trigger information, beta-offset information, and so on.

Additionally, DCI field Type 1 may include BWP (index) indicator information, CSI feedback request information, DMRS-sequence initialization information, and so on.

2) Opt 1: Conventionally, one entry corresponding to scheduling information for a single cell is mapped to/configured for each state. In the case of multi-CC DCI, a new entry (pair) table/set may be configured for the purpose of multi-CC scheduling, such that two cells (e.g., cell 1 and cell 2) subject to multi-CC scheduling share a single field, and an entry pair (entry for cell 1, entry 2 for cell 2) for the two cells is mapped to each state.

Table 5 shows an example of Opt 1.

TABLE 5

| Field state | Mapping information (Entry set) |
|---|---|
| . . . | . . . |
| n | n^{th} entry set configured by a higher layer (e.g., RRC) |
| n + 1 | (n + 1)^{th} entry set configured by a higher layer (e.g., RRC) |
| . . . | . . . |

Note:
Each entry set includes (entry 1 for cell 1, entry 2 for cell 2, . . . )
For example, each entry set consists of entry pair for two cells.

For example, in the case of a TDRA table configured for indication of a TDRA field, for the PDSCH, a pair of entries each being {DCI-to-PDSCH timing (slot offset K0), PDSCH starting/length (SLIV), PDSCH mapping type (A or B)} (one entry for each of cell 1 and cell 2) are mapped to/configured for each state of the TDRA field. For the PUSCH, a pair of entries each being {DCI-to-PUSCH timing (slot offset K2), PUSCH starting/length (SLIV), PUSCH mapping type (A or B)} (one entry for each of cell 1 and cell 2) are mapped to/configured for each state of the TDRA field.

In another example, in the case of a K1 set configured for indication of an HARQ-ACK timing field, an entry pair {K1 for cell 1, K1 for cell 2} may be mapped to/configured for each state of the HARQ-ACK timing field.

When only one of cell 1 and cell 2 is scheduled by the multi-CC DCI, only an entry for the cell may be selected from (a pair corresponding to an indicated state in) an entry table/set for multi-CC scheduling and applied to the cell, or an entry (corresponding to the indicated state) may be selected from an entry table/set for single-cell scheduling configured for the cell and applied to the cell.

Additionally, when the entry table/set for multi-CC scheduling is separately configured/constructed, a different number of entries/a different entry combination (the number of cells/a cell combination) may be configured for each state of DCI field Type 1. For example, an entry pair for multi-CC may be mapped to a state, and a single entry for one cell may be mapped to another state. Accordingly, multi-CC scheduling (or single-cell scheduling) may be determined according to the number of entries/cells and/or an entry/cell combination mapped to/configured for a state indicated by a specific (e.g., TDRA or K1) field. Further, an entry pair for two CCs may be configured for every state, and when an entry for a CC is set to an invalid value (e.g., invalid SLIV, invalid K1, or invalid CI) in a specific state, the CC may be excluded from scheduling.

Tables 6 and 7 show other examples of Opt 1.

TABLE 6

| Field state | Mapping information (Entry set) |
|---|---|
| . . . | . . . |
| n | n^{th} entry set configured by a higher layer (e.g., RRC) |
| n + 1 | (n + 1)^{th} entry set configured by a higher layer (e.g., RRC) |
| . . . | . . . |

Note:
Each entry set includes a respective entry/combination
For example, n^{th} entry set consists of a single entry for one cell (here, cell may be a default scheduled cell specified based on a predefined rule), and (n + 1)^{th} entry set consists of multi-entries (e.g., an entry pair) for multi-CC scheduling

TABLE 7

| | Mapping information | |
|---|---|---|
| | (Entry set) configured by a higher layer | |
| Field state | entry for cell 1 | entry for cell 2 |
| . . . | . . . | . . . |
| n | Valid information | Invalid information |
| n + 1 | Valid information | Valid information |
| . . . | . . . | . . . |

Note:
Each entry set includes (entry 1 for cell 1, entry 2 for cell 2, . . . ), but some entry may be set to invalid information.
For example, each entry set consists of entry pair for two cells. Here, n^{th} entry set includes valid information for cell 1 and invalid information for cell 2, and so cell 1 is scheduled and cell 2 is excluded from scheduling. But, (n + 1)^{th} entry set includes valid information for cell 1 and cell 2, and so cell 1 and cell 2 are scheduled.

3) Opt 2: Two cells (cell 1 and cell 2) subject to multi-CC scheduling share a single field. A state indicated by a corresponding field may be interpreted as an entry (corresponding to the state) in an entry table/set for single-cell scheduling configured for a specific one of cell 1 and cell 2 (e.g., a cell with a lowest cell index, a PCell (when included in multi-CC), a (scheduling) cell carrying DCI, or a cell corresponding to a CIF in multi-CC DCI), and the entry may be applied commonly to cell 1 and cell 2.

Table 8 shows an example of Opt 2.

TABLE 8

| Field | |
|---|---|
| state | Mapping information (Single entry) |
| . . . | . . . |
| n | n^{th} entry configured by a higher layer (e.g., RRC), which is for a |
| | specific one of plural cells (e.g., two cells) |
| n + 1 | (n + 1)^{th} entry configured by a higher layer (e.g., RRC), which is |
| | for a specific one of plural cells (e.g., two cells) |
| . . . | . . . |

Note:
Each entry is commonly applied to all of the plural cells

For example, in the TDRA field, an entry combination {K0 or K2, PDSCH or PUSCH starting/length (SLIV), PDSCH or PUSCH mapping type (A or B)} mapped to a state indicated by the TDRA field in a (single-cell scheduling) TDRA table configured for the specific cell may be applied commonly to cell 1 and cell 2,

In another example, in the case of the HARQ-ACK timing field, a K1 value mapped to a state indicated by the HARQ-ACK timing field in a (single-cell scheduling) K1 set configured for the specific cell may be applied commonly to cell 1 and cell 2.

When only one of cell 1 and cell 2 is scheduled by the multi-CC DCI, an entry (corresponding to an indicated state) may be selected from an entry table/set for single-cell scheduling configured for the cell and applied to the cell.

4) Opt 3: Two cells (cell 1 and cell 2) subject to multi-CC scheduling share a single field. A state indicated by the field may be interpreted as entries (corresponding to the state) in entry tables/sets for single-cell scheduling configured for cell 1 and cell 2 and applied to cell 1 and cell 2, respectively.

Table 9 shows an example of Opt 3.

TABLE 9

| Field | Mapping information (Single entry per cell) | |
|---|---|---|
| state | Cell 1 | Cell 2 |
| . . . | . . . | . . . |
| n | n^{th} entry configured by a | n^{th} entry configured by a higher |
| | higher layer (e.g., RRC) | layer (e.g., RRC) |
| n + 1 | (n + 1)^{th} entry configured by | (n + 1)^{th} entry configured by a |
| | a higher layer (e.g., RRC) | higher layer (e.g., RRC) |
| . . . | . . . | . . . |

Note:
Entries are separately configured per cell by a higher layer (e.g., RRC)

For example, in the case of the TDRA field, an entry combination {K0 or K2, PDSCH or PUSCH starting/length (SLIV), PDSCH or PUSCH mapping type (A or B)} mapped to a state indicated by the TDRA field in a TDRA table (for single-cell scheduling) configured for each of cell 1 and cell 2 may be applied to the cell.

In another example, in the case of the HARQ-ACK timing field, a K1 value mapped to a state indicated by the HARQ-ACK timing field in a K1 set (for single-cell scheduling) configured for each of cell 1 and cell 2 may be applied to the cell.

[DCI Field Type 2]

1) DCI field Type 2 refers to the type/information of a DCI field with each state mapped to information/a value predefined (in a specification).

For example, DCI field Type 2 may include frequency domain RA (FDRA) information, MCS information, NDI/RV information, HARQ process ID information, PRB bundling information, DAI information, TPC information, antenna port information, and so on.

2) Information/values indicated by the above fields are almost independent between cell 1 and cell 2 (inevitably because state-to-entry mapping is not configurable, compared to DCI field Type 1). Thus, (two) individual fields may be configured for the respective cells, cell 1 and cell 2.

When an individual field is configured for each of the two cells as described above, DCI overhead may be increased as much.

Opt 1: The size of an individual field for each of cell 1 and cell 2 may be decreased to be smaller than a field size defined for legacy single-cell scheduling, and the individual field may restrictively indicate a specific part of total entries (available for indication by the field) defined for the legacy single-cell scheduling.

Table 10 shows an example of Opt 1.

TABLE 10

| | Single CC scheduling | Multi-CC scheduling | |
|---|---|---|---|
| Entry | N bits | N1 bits for Cell 1 | N2 bits for Cell 2 |
| a | Available | N/A | N/A |
| b | Available | Available | Available |
| c | Available | Available | Available |
| d | Available | N/A | N/A |

Note:
N1 < N, N2 < N (e.g., N1 + N2 = N)

For example, an RV field indicates one of RV values {0, 1, 2, 3} in two bits in the legacy single-cell scheduling. In the case of multi-CC DCI, the RV field may indicate one of values {0, 3} or {0, 2} in one bit for each of cell 1 and cell 2.

In another example, an HARQ process ID field indicates one of (up to) 16 IDs in (up to) 4 bits in the legacy single-cell scheduling. In the case of the multi-CC DCI, the HARQ process ID field may be indicate one of (up to) 4 IDs in (up to) 2 bits for each of cell 1 and cell 2.

Opt 2: The size of an individual field for each of cell 1 and cell 2 may be decreased to be smaller than the field size defined for the legacy single-cell scheduling, while the size of an RBG being a resource allocation unit (given according to a BW size) defined for the legacy single-cell scheduling may be increased.

Table 11 shows an example of Opt 2.

TABLE 11

| Single CC scheduling | Multi-CC scheduling | |
|---|---|---|
| N bits | N1 bits for Cell 1 | N2 bits for Cell 2 |
| RBG-based resource | RBG-based resource | RBG-based resource |
| allocation | allocation | allocation |
| (RBG size = M RBs) | (RBG size = M1 RBs) | (RBG size = M2 RBs) |

Note:
N1 < N, N2 < N (e.g., N1 + N2 = N);
M is a value determined as a function of a bandwidth of a scheduled cell/CC.
Each of M1 and M2 is respectively less than a value determined as a function of a bandwidth of a corresponding scheduled cell/CC

For example, in the case of an FDRA field, an RBG size for a specific BW size may be configured/indicated as Nr in the legacy single-cell scheduling. In contrast, in the case of the multi-CC DCI, the RBG size may be configured/indicated as a larger value than Nr, for the same BW size.

3) Exceptionally, cell 1 and cell 2 share the single FDRA field and RA information indicated by the FDRA field may be applied commonly to cell 1 and cell 2.

Opt 1: The size of the FDRA field may be determined according to the minimum B_min of the BW sizes of cell 1 and cell 2 (BWPs configured for/indicated to cell 1 and cell 2).

In this case, for a cell (operating in a BWP) configured with a larger BW than B_min, RA information indicated by the FDRA field may be applied to a frequency area of the size B_min corresponding to a lower frequency in the BW.

Opt 2: The size of the FDRA field may be determined according to the maximum B_max of the BW sizes of cell 1 and cell 2 (the BWPs configured for/indicated to cell 1 and cell 2).

In this case, when RA information indicated by the FDRA field indicates resources beyond the BW size of a specific cell (of the BWP configured/indicated for the specific cell) or a highest PRB index, it may be assumed that the total BW of (the BWP of) the cell has been allocated.

[DCI Field Type 3]

DCI field Type 3 refers to the type/information of a DCI field with states one of which includes a “no trigger” or “no change” operation.

Table 12 shows an example of DCI field Type 3.

TABLE 12

| | Single | |
|---|---|---|
| Field | CC scheduling | Multi-CC scheduling |
| Trigger | Applied to a | For a specific cell, trigger (or |
| (change) | scheduled cell | change) is applied |
| | | For the other cell(s), no trigger (or |
| | | no change) is applied |
| No trigger | Applied to a | Applied to a cell group configured |
| (no change) | scheduled cell | for multi-CC scheduling |

For example, DCI field type 3 may include BWP (index) indicator information, SRS transmission trigger information, frequency hopping flag information, UL-SCH presence or absence indicator information, CSI feedback request information, and so on.

For the above fields, there may not a lot of needs/cases of indicating trigger/change (of operations corresponding to the fields) at the same time for both of cell 1 and cell 2. In this context, it may be assumed for multi-CC DCI that a corresponding field is applied only to a specific one of cell 1 and cell 2 (e.g., a cell with a lowest cell index, a PCell (when included in multi-CC), a (scheduling) cell carrying DCI, or a cell corresponding to a CIF indicated by multi-CC DCI), and no trigger or no change is indicated for the other cell.

For example, (when both of cell 1 and cell 2 have been scheduled,) a (BWP switching) operation indicated by a BWP indicator field may be applied only to the specific cell, while no BWP change may be assumed for the other cell.

In another example, (when both of cell 1 and cell 2 have been scheduled,) an (aperiodic CSI on PUSCH) operation indicated by a CSI request field may be applied only to the specific cell, while no CSI request may be assumed for the other cell.

In another example, (when both of cell 1 and cell 2 have been scheduled,) an (aperiodic SRS transmission) operation indicated by an SRS trigger field may be applied only to the specific cell, while no SRS trigger may be assumed for the other cell.

When only one of cell 1 and cell 2 is scheduled by the multi-CC DCI, (trigger/change) information indicated by the field may be applied to the cell (i.e., the scheduled cell).

[DCI Field Type 4]

DCI field Type 4 refers to the type/information of a DCI field for which its presence or absence is configurable, wherein in the absence of the DCI field, default information/a default value predefined (in a technical specification) is applied.

For example, DCI field type 4 may include CBGTI information, CBGFI information, DMRS-sequence initialization information, PTRS-DMRS association information, and so on.

Information/values indicated by the above fields may be almost independent between the two cells, cell 1 and cell 2, and their default information/values applied in the absence of the fields (in DCI) may not cause serious performance degradation. Accordingly, the fields may be applied only to a specific one of cell 1 and cell 2 (e.g., a cell with a lowest cell index, a PCell (when included in multi-CC), a (scheduling) cell carrying DCI, or a cell corresponding to a CIF in multi-CC DCI), while the default information/values may be applied to the other cell.

For example, when both of cell 1 and cell 2 have been scheduled, information indicated a DMRS-sequence initialization field may be applied only to a specific cell (referring to a set/table of DMRS-sequence initialization values configured for the specific cell), and a default value (e.g., a physical cell ID (PCI)) may be applied to the other cell.

When only one of cell 1 and cell 2 is scheduled by the multi-CC DCI, information/values indicated by the fields (instead of the default information/values) may be applied to the cell.

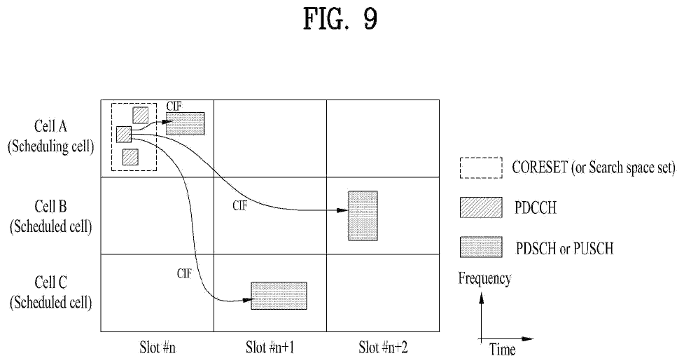

FIG. 9 illustrates multi-CC/cell scheduling. Referring to FIG. 9, it is assumed that three cells are aggregated. When single-CC/cell scheduling is configured, DCI on a PDCCH transmitted in a scheduling cell includes scheduling information for one scheduled cell (i.e., single-CC DCI). On the contrary, when multi-CC/cell scheduling is configured, DCI on a PDCCH transmitted in a scheduling cell may include scheduling information for a plurality of CCs/cells configured for the multi-CC/cell scheduling (i.e., multi-CC DCI). Data may be transmitted and received in at least one of the plurality of CCs/cells based on the scheduling information in the multi-CC DCI.

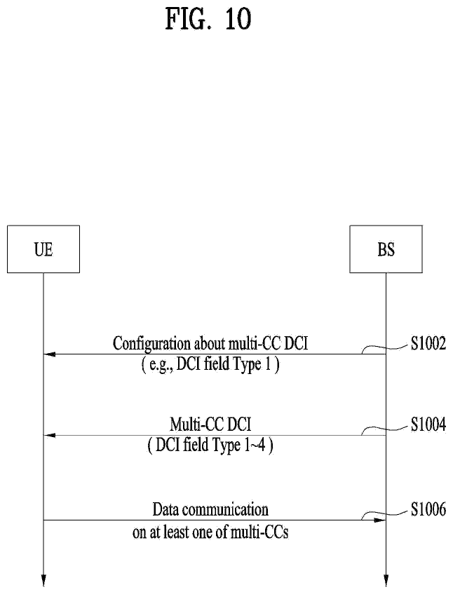

FIG. 10 illustrates an exemplary data transmission and reception procedure according to an example of the disclosure. Referring to FIG. 10, a BS transmits configuration information about multi-CC DCI to a UE (S1002). For example, the configuration information may include information about DCI field Types (e.g., DCI field Type 1 to DCI field Type 4) proposed in the present disclosure. Further, the configuration information may include information about a scheduling cell and a scheduled cell (group) to which the multi-CC DCI is applied. Subsequently, the BS may transmit the multi-CC DCI to the UE (S1004). The multi-CC DCI may include DL scheduling information and/or UL scheduling information, and may be composed of DCI field Types (e.g., DCI field Type 1 to DCI field Type 4) proposed in the present disclosure. The BS and the UE may then perform data communication in at least one of multiple CCs/cells, as illustrated in FIG. 9 (S1006).

The various descriptions, functions, procedures, proposals, methods, and/or operational flowcharts proposals of the present disclosure described above in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

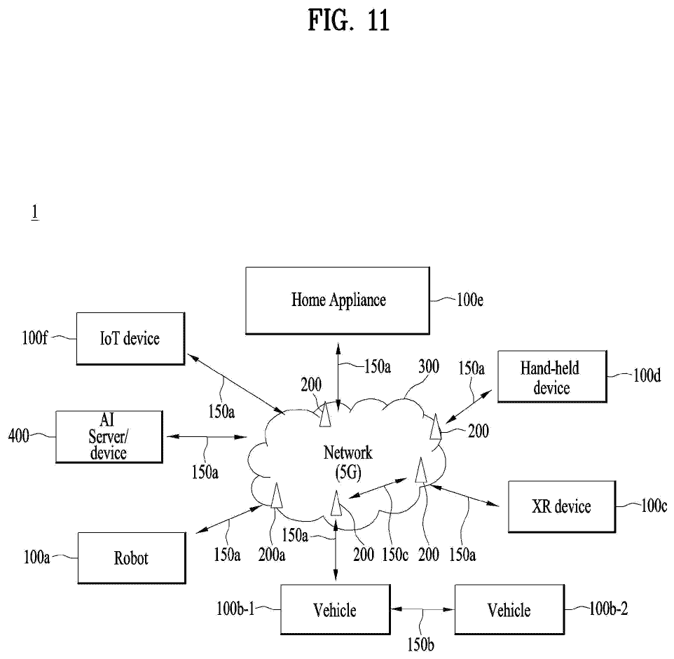

FIG. 11 illustrates a communication system 1 applied to the present disclosure.

Referring to FIG. 11, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul(IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

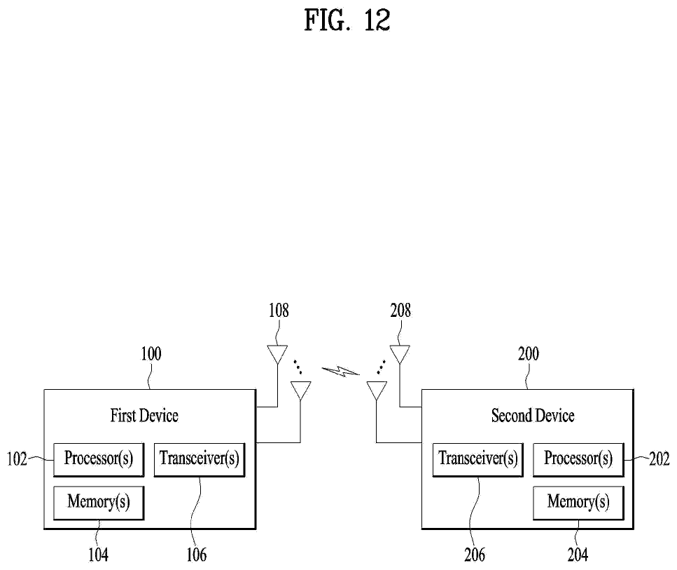

FIG. 12 illustrates wireless devices applicable to the present disclosure.

Referring to FIG. 12, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 11.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

In the present disclosure, at least one memory (e.g., 104 or 204) may store instructions or programs which, when executed, cause at least one processor operably coupled to the at least one memory to perform operations according to some embodiments or implementations of the present disclosure.

In the present disclosure, a computer-readable storage medium may store at least one instruction or computer program which, when executed by at least one processor, causes the at least one processor to perform operations according to some embodiments or implementations of the present disclosure.

In the present disclosure, a processing device or apparatus may include at least one processor and at least one computer memory coupled to the at least one processor. The at least one computer memory may store instructions or programs which, when executed, cause the at least one processor operably coupled to the at least one memory to perform operations according to some embodiments or implementations of the present disclosure.

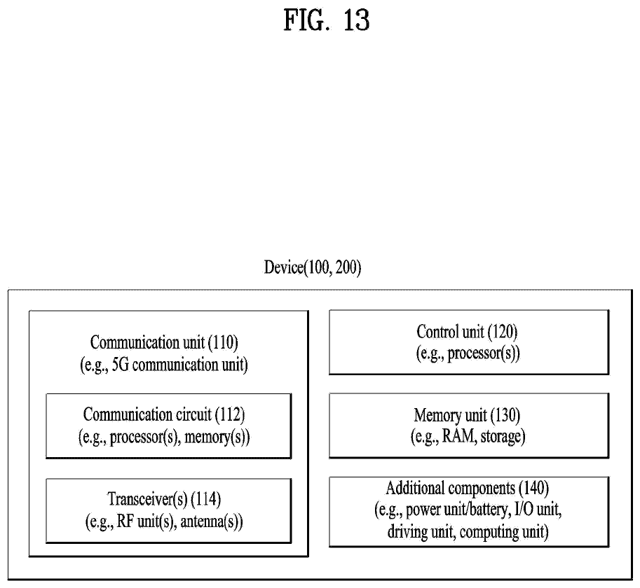

FIG. 13 illustrates another example of a wireless device applied to the present disclosure. The wireless device may be implemented in various forms according to a use-case/service (refer to FIG. 11).

Referring to FIG. 13, wireless devices 100 and 200 may correspond to the wireless devices 100 and 200 of FIG. 12 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 12. For example, the transceiver(s) 114 may include the one or more transceivers 106 and 206 and/or the one or more antennas 108 and 208 of FIG. 12. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 11), the vehicles (100b-1 and 100b-2 of FIG. 11), the XR device (100c of FIG. 11), the hand-held device (100d of FIG. 11), the home appliance (100e of FIG. 11), the IoT device (100f of FIG. 11), a digital broadcast terminal, a hologram device, a public safety device, an MTC device, a medicine device, a fintech device (or a finance device), a security device, a climate/environment device, the AI server/device (400 of FIG. 11), the BSs (200 of FIG. 11), a network node, etc. The wireless device may be used in a mobile or fixed place according to a use-example/service.

In FIG. 13, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

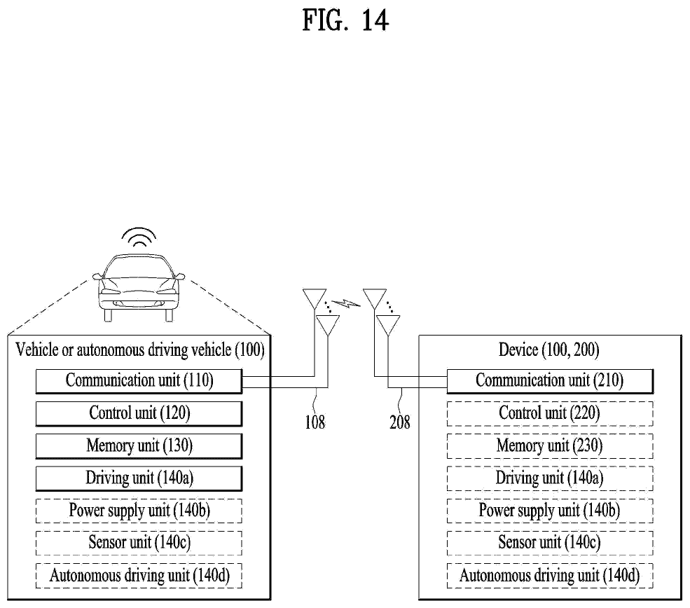

FIG. 14 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 14, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 13, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the present disclosure in prescribed forms. And, the respective elements or features may be considered as selective unless they are explicitly mentioned. Each of the elements or features can be implemented in a form failing to be combined with other elements or features. Moreover, it is able to implement an embodiment of the present disclosure by combining elements and/or features together in part. A sequence of operations explained for each embodiment of the present disclosure can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

The present disclosure is applicable to UEs, eNBs or other apparatuses of a wireless mobile communication system.

What is claimed is:

1. A method used by a user equipment in a wireless communication system, the method comprising:
receiving downlink control information (DCI) defined for multi-carrier scheduling, the DCI including:
resource allocation information for one or more carriers, and
a single field for bandwidth part switching; and
performing a bandwidth part switching operation on one of multi-carriers,
wherein, based on two or more carriers being scheduled by the DCI, the bandwidth part switching operation is performed on one of the multi-carriers based on a pre-determined rule, and
wherein, based on one carrier being scheduled by the DCI, the bandwidth part switching operation is performed on the scheduled carrier of the multi-carriers.

2. The method of claim 1, wherein the pre-determined rule includes: the bandwidth part switching operation is performed on one of the multi-carriers having a lowest cell index.

3. The method of claim 1, wherein the pre-determined rule includes: the bandwidth part switching operation is performed on a primary cell (PCell) of the multi-carriers.

4. The method of claim 1, wherein the pre-determined rule includes: the bandwidth part switching operation is performed on a scheduling cell of the multi-carriers.

5. The method of claim 1, wherein DCI further includes:
2-bit redundancy version (RV) field,
wherein based on two carriers being scheduled by the DCI, each 1-bit value of the RV field indicates one of two RVs {0, x} (x is 2 or 3) for a respective one of the multi-carriers, and
wherein, based on one carrier being scheduled by the DCI, 2-bit value of the RV field indicates one of four RVs {0, 1, 2, 3} for the scheduled carrier of the multi-carriers.

6. A user equipment (UE) used in a wireless communication system, the UE comprising:
at least one radio frequency (RF) units;
at least one processor; and
at least one computer memory operably coupled to the at least one processor and, when executed, causing the at least one processor to perform operations,
wherein the operations include:
receiving downlink control information (DCI) defined for multi-carrier scheduling, the DCI including:
resource allocation information for one or more carriers, and
a single field for bandwidth part switching; and
performing a bandwidth part switching operation on one of multi-carriers,
wherein, based on two or more carriers being scheduled by the DCI, the bandwidth part switching operation is performed on one of the multi-carriers based on a pre-determined rule, and
wherein, based on one carrier being scheduled by the DCI, the bandwidth part switching operation is performed on the scheduled carrier of the multi-carriers.

7. The UE of claim 6, wherein the pre-determined rule includes: the bandwidth part switching operation is performed on one of the multi-carriers having a lowest cell index.

8. The UE of claim 6, wherein the pre-determined rule includes: the bandwidth part switching operation is performed on a primary cell (PCell) of the multi-carriers.

9. The UE of claim 6, wherein the pre-determined rule includes: the bandwidth part switching operation is performed on a scheduling cell of the multi-carriers.

10. The UE of claim 6, wherein DCI further includes:
2-bit redundancy version (RV) field,
wherein based on two carriers being scheduled by the DCI, each 1-bit value of the RV field indicates one of two RVs {0, x} (x is 2 or 3) for a respective one of the multi-carriers, and
wherein, based on one carrier being scheduled by the DCI, 2-bit value of the RV field indicates one of four RVs {0, 1, 2, 3} for the scheduled carrier of the multi-carriers.

11. A method used by a base station in a wireless communication system, the method comprising:
transmitting downlink control information (DCI) defined for multi-carrier scheduling, the DCI including:
resource allocation information for one or more carriers, and
a single field for bandwidth part switching; and
performing a bandwidth part switching operation on one of multi-carriers,
wherein, based on two or more carriers being scheduled by the DCI, the bandwidth part switching operation is performed on one of the multi-carriers based on a pre-determined rule, and
wherein, based on one carrier being scheduled by the DCI, the bandwidth part switching operation is performed on the scheduled carrier of the multi-carriers.

12. The method of claim 11, wherein the pre-determined rule includes: the bandwidth part switching operation is performed on one of the multi-carriers having a lowest cell index.

13. The method of claim 11, wherein the pre-determined rule includes: the bandwidth part switching operation is performed on a primary cell (PCell) of the multi-carriers.

14. The method of claim 11, wherein the pre-determined rule includes: the bandwidth part switching operation is performed on a scheduling cell of the multi-carriers.

15. The method of claim 11, wherein DCI further includes:
2-bit redundancy version (RV) field,
wherein based on two carriers being scheduled by the DCI, each 1-bit value of the RV field indicates one of two RVs {0, x} (x is 2 or 3) for a respective one of the multi-carriers, and
wherein, based on one carrier being scheduled by the DCI, 2-bit value of the RV field indicates one of four RVs {0, 1, 2, 3} for the scheduled carrier of the multi-carriers.

16. A base station (BS) used in a wireless communication system, the BS comprising:
at least one radio frequency (RF) units;
at least one processor; and
at least one computer memory operably coupled to the at least one processor and, when executed, causing the at least one processor to perform operations,
wherein the operations include:
transmitting downlink control information (DCI) defined for multi-carrier scheduling, the DCI including:
resource allocation information for one or more carriers, and
a single field for bandwidth part switching; and
performing a bandwidth part switching operation on one of multi-carriers,
wherein, based on two or more carriers being scheduled by the DCI, the bandwidth part switching operation is performed on one of the multi-carriers based on a pre-determined rule, and
wherein, based on one carrier being scheduled by the DCI, the bandwidth part switching operation is performed on the scheduled carrier of the multi-carriers.

17. The BS of claim 16, wherein the pre-determined rule includes: the bandwidth part switching operation is performed on one of the multi-carriers having a lowest cell index.

18. The BS of claim 16, wherein the pre-determined rule includes: the bandwidth part switching operation is performed on a primary cell (PCell) of the multi-carriers.

19. The BS of claim 16, wherein the pre-determined rule includes: the bandwidth part switching operation is performed on a scheduling cell of the multi-carriers.

20. The BS of claim 16, wherein DCI further includes:
2-bit redundancy version (RV) field,
wherein based on two carriers being scheduled by the DCI, each 1-bit value of the RV field indicates one of two RVs {0, x} (x is 2 or 3) for a respective one of the multi-carriers, and
wherein, based on one carrier being scheduled by the DCI, 2-bit value of the RV field indicates one of four RVs {0, 1, 2, 3} for the scheduled carrier of the multi-carriers.
